(19) United States
(12) Patent Application Publication
(10) Pub. No.: US 2002/0154351 A1
(43) Pub. Date: Oct. 24, 2002

(54) Optical network architecture with reduced equipment

(76) Inventor: Lee Daniel Feinberg, Silver Spring, MD (US)

Correspondence Address: Johnny A. Kumar, FOLEY & LARDNER, Washington Harbour, 3000 K Street, N.W., Suite 500, Washington, DC, 20007-5109, US

(21) Appl. No.: 09/840,296

(22) Filed: Apr. 24, 2001

(51) Int. Cl. H04B 10/08; H04B 10/12

(52) U.S. Cl. 359/110; 359/173

(57) ABSTRACT

An optical network with at least two nodes is provided comprising optical fiber, at least two active fiber-bays per node optically coupled to the fiber, and at least one redundant fiber-bay per node optically coupled to the fiber. When an active fiber-bay fails, the network changes from the failed fiber-bay to a redundant fiber-bay. Further, the number of redundant fiber-bays is less than the number of active fiber-bays.

### BACKGROUND OF THE INVENTION

A. Field of the Invention

The invention relates generally to a network architecture, and more particularly to an optical network architecture which has redundant fiber-bays, redundant channel equipment, and/or redundant optical fiber.

B. Background of the Invention

For network architectures, a problem exists where a connection between two nodes fails for any number of reasons. There is a need to have a fiber optic system that can still operate even when a connection fails, while minimizing bandwidth loss during normal communication.

Typically, conventional optical communication systems comprise a receiving node and a transmitting node connected via optical fiber. Each node contains equipment for communication via an optical fiber. Such equipment includes channel equipment and wave division multiplexing (WDM) equipment. Channel equipment is equipment that transmits and receives via a specific channel. A fiber-bay includes a group of channel and WDM equipment that transmits and receives a specific optical fiber. Each fiber-bay may comprise a plurality of racks with a plurality of channel and WDM equipment associated with a fiber pair (a transmit and a receive fiber) depending on the specific implementation. Multiple fiber-bays are located in each of the nodes.

Connection failures generally fall into one of three categories: (1) physical cuts in the optical fiber (“fiber cut”); (2) individual channel equipment failure within a fiber-bay (“channel failure”); and (3) multiple channel equipment failure within a fiber-bay (“fiber-bay failure”). Fiber-bay failures may further include situations where an entire fiber-bay fails, including loss of power to the entire fiber-bay, or the failure of a common component to all the channel equipment such as the final multiplexer.

In a conventional optical communication system, communication takes place via an optical fiber between a receiving node and a transmitting node. Active fiber-bays at a receiving node and active fiber-bays at a transmitting node transmit data between the nodes via the optical fiber during normal communication.

To protect against channel failures, a conventional system will employ backup channel equipment at each node. When a channel failure occurs, such as the failure of a transmitting laser, the network will switch to redundant channel equipment within the node with the failed channel equipment.

A more advanced conventional system may further comprise fiber cut protection. To protect against fiber cuts, an advanced conventional system will employ an additional optical fiber between the two nodes. The primary optical fiber is called a service optical fiber. A backup optical fiber is called a protect optical fiber. Typically, unidirectional optical fiber is utilized in submarine optical communication systems rather than bi-directional optical fiber. When a fiber cut in a service optical fiber occurs, the system utilizes protect optical fiber employed between the nodes as a backup.

An advanced conventional network architecture comprising service and protect optical fiber to compensate for fiber cuts, and redundant channel equipment to compensate for channel equipment failure is described in Optical Networks, A Practical Perspective by Rajiv Ramaswami and Kumar Sivarajan.

An advanced conventional network architecture may further comprise a plurality of nodes each connected as described above. A typical mesh architecture as is common in internet protocol routing may incorporate such a network architecture.

### SUMMARY OF THE INVENTION

In a first aspect of the present invention, an optical network with at least two nodes is provided comprising optical fiber, at least two active fiber-bays per node optically coupled to the fiber, and at least one redundant fiber-bay per node optically coupled to the fiber. When an active fiber-bay of the at least two active fiber-bays fails, the network changes from the failed fiber-bay to a redundant fiber-bay of the at least one redundant fiber-bay. The number of the at least one redundant fiber-bays is less than the number of the at least two active fiber-bays.

In another aspect of the present invention, an optical network with at least two nodes is provided comprising optical fiber, at least two active fiber-bays per node optically coupled to the fiber, and at least one redundant fiber-bay per node optically coupled to the fiber. The optical fiber comprises a service transmit optical fiber, a protect transmit optical fiber, a service receive optical fiber, and a protect receive optical fiber. The fiber-bays comprise active channel equipment, and redundant channel equipment. When a channel equipment fails, the fiber-bay changes from the failed channel equipment to the redundant channel equipment. When an active fiber-bay fails, the network changes from the failed fiber-bay to a redundant fiber-bay. The number of redundant fiber-bays is less than the number of active fiber-bays. The network changes from the service transmit optical fiber to the protect transmit optical fiber when the service transmit optical fiber fails. The network changes from the service receive optical fiber to the protect receive optical fiber when the service receive optical fiber fails.

In another aspect of the present invention, a method of transporting a signal via optical fiber is provided comprising the steps of transmitting an optical signal via an active optical fiber, changing to a redundant optical fiber when a cut in an active optical fiber occurs, and changing to a redundant fiber-bay when an active fiber-bay fails. The number of redundant fiber-bays is less than the number of active fiber-bays.

Thus, an optical network architecture which has redundant bays, channels, and/or optical fiber has been described according to several examples of the present invention. Many modifications and variations may be made to the techniques and structures described and illustrated herein without departing from the spirit and scope of the invention. Accordingly, it should be understood that the methods and apparatus described herein are illustrative only and are not limiting upon the scope of the invention.

### BRIEF DESCRIPTION OF THE DRAWINGS

The foregoing advantages and features of the invention will become apparent upon reference to the following detailed description and the accompanying drawings, of which:

FIG. 1 is a block diagram of a first optical network according to the present invention;

FIG. 2 is a block diagram of a first node according to the present invention.

FIG. 3 is a block diagram of a fiber-bay according to the present invention.

FIG. 4 is a block diagram of a second node according to the present invention.

FIG. 5 is a block diagram of a third node according to the present invention.

### DETAILED DESCRIPTION OF PREFERRED EMBODIMENTS

A network architecture consistent with the present invention comprises redundant fiber-bays as well as redundant channel equipment and/or redundant optical fiber.

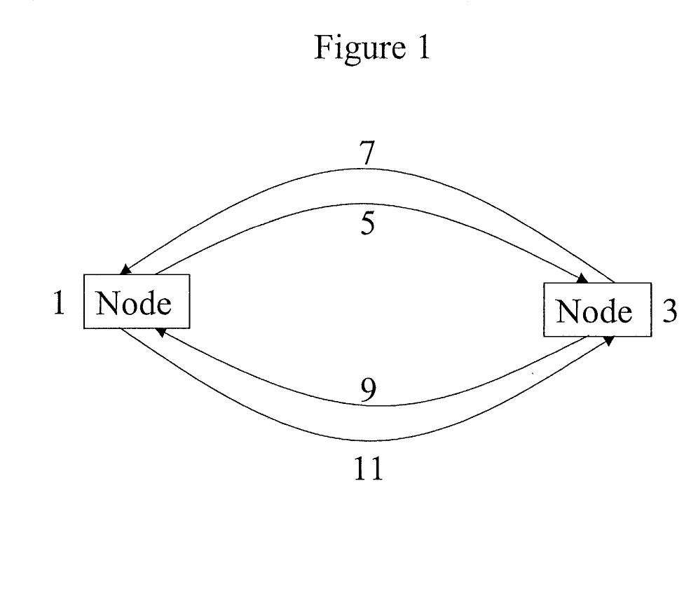

In a first embodiment, two nodes communicate via optical fiber. FIG. 1 illustrates nodes 1 and 3 communicating via optical fibers 5, 7, 9, and 11. For example, node 1 may be a communication facility located in London, England, and node 2 may be a communication facility located in New York, United States. Service transmit optical fiber 5 and service receive optical fiber 7 are optically coupled to nodes 1 and 3. Protect transmit optical fiber 11 and protect receive optical fiber 9 are also optically coupled to nodes 1 and 3. Optionally, protect optical fibers 9 and 11 may be omitted in a network where fiber cut protection is not required.

If a fiber-cut occurs in service transmit optical fiber 5, the network changes to use protect transmit optical fiber 11. If a fiber-cut occurs in service receive optical fiber 7, the network changes to use protect receive optical fiber 9. The network may utilize software to control switches to change from the service to the protect optical fiber.

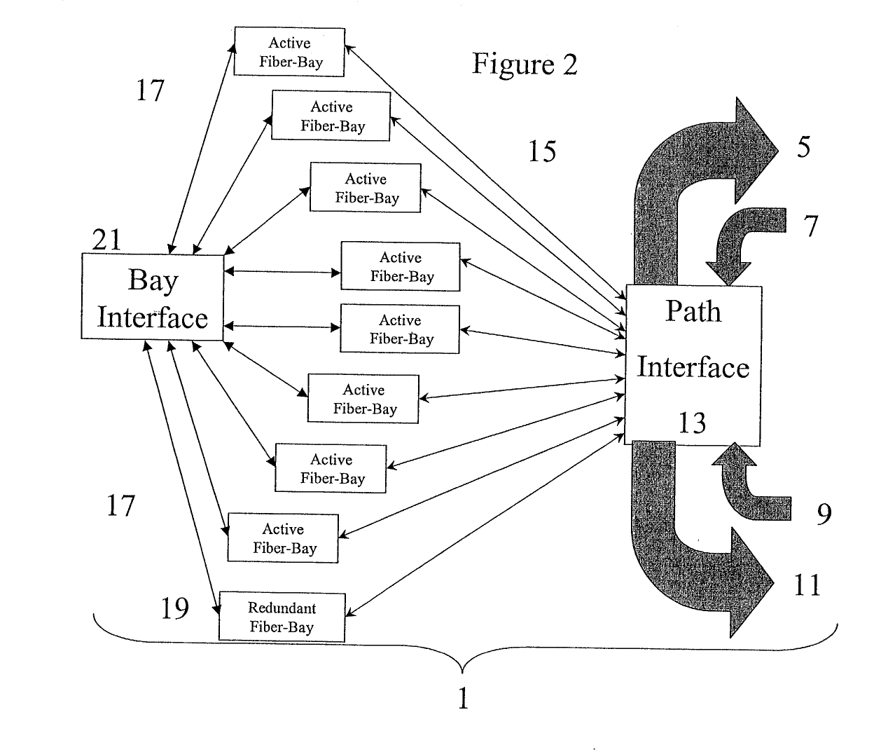

In a second embodiment, two nodes communicate via optical fiber (FIG. 1). A single node is shown in FIG. 2. Optical fibers 5, 7, 9, and 11 are optically coupled to path interface 13 at a first node, and optically coupled to a second node at another site (FIG. 1). Path interface 13 is further optically coupled to optical fiber 15. A plurality of active fiber-bays 17 are optically coupled to optical fiber 15. Redundant fiber-bay 19 is also optically coupled to optical fiber 15. Bay interface 21 may be provided to couple fiber-bays 17 and 19 with data lines external to the optical network.

In this second embodiment, communication via optical fiber occurs between the first node and second node via service optical fibers 5 and 7 (FIG. 1). If a fiber-cut occurs causing a failure in the optical fiber, path interface 13 changes from using the failed service optical fiber to the redundant protect optical fiber. Optical fiber changing may be accomplished by an overhead software management tool that monitors signal strength and utilizes switches to switch from the service to the protect optical fiber. Similarly, if an active fiber-bay 17 fails, path interface 13 may idle the faulty fiber-bay and activate redundant fiber-bay 19.

Any number of redundant fiber-bays 19 may be provided in the optical transmission system, wherein the number of redundant fiber-bays 19 is less than the number of active fiber-bays 17.

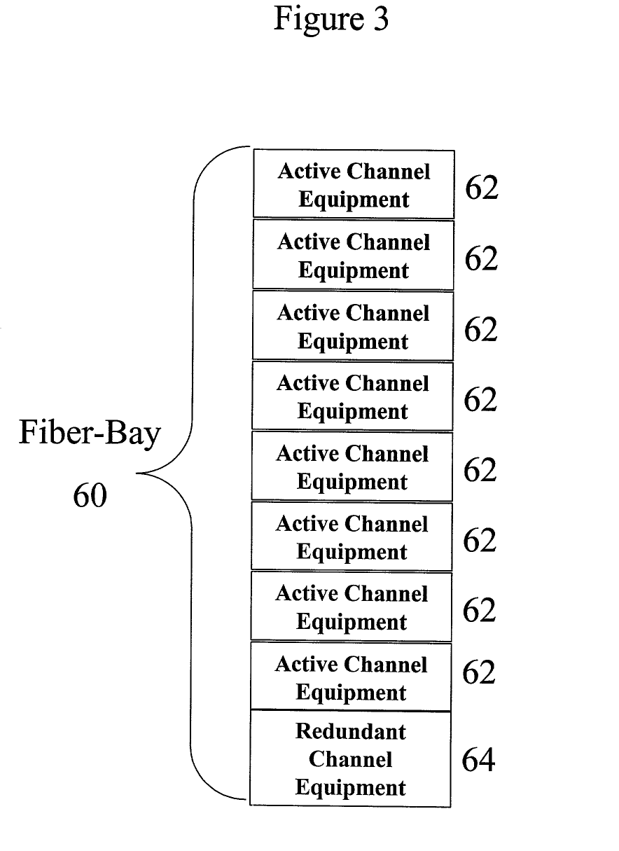

In a third embodiment as shown in FIG. 3, fiber-bay 60 is shown in block diagram. Fiber-bay 60 may be an active fiber-bay and/or a redundant fiber-bay. Fiber-bay 60 comprises a plurality of active channel equipment 62, and at least one redundant channel equipment 64. Channel equipment typically comprises a plurality of transmit-receive modules, which contain the necessary equipment to transmit and receive an optical channel. These modules may include, for example, laser sources, amplifiers, optical receivers, forward error correction (FEC) circuitry, and modulators. Typically, multiplexers and demultiplexers are provided at the fiber-bay level, and are generally not repeated individually per channel.

When a channel failure occurs within fiber-bay 60, fiber-bay 60 activates redundant channel equipment 64 and idles the failed channel equipment. Any number of redundant equipment 64 may be provided within a bay of equipment. In a preferred embodiment, two redundant channel equipment transmitting and receiving at 10 Gbps are provided per 254 active channel equipment.

By utilizing redundant channel equipment within a fiber-bay, switching to an entire redundant fiber-bay of equipment may not be necessary to accommodate a channel failure. Thus, a reduction in the total number of fiber-bays is achieved while still providing redundant channel equipment, resulting in adequate system performance at a reduced cost.

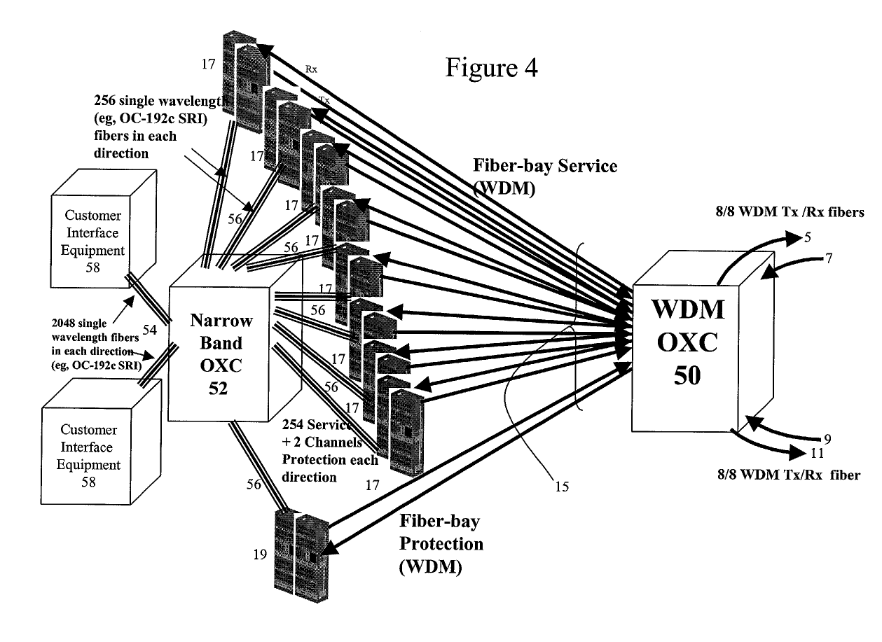

In a fourth embodiment, two nodes communicate via optical fiber (FIG. 1). A single node is shown in FIG. 4. Optical fibers 5, 7, 9, and 11 are optically coupled to WDM optical cross-connect (OXC) 50 at a first node, and optically coupled to a second node at another site (FIG. 1). WDM OXC 50 is further optically coupled to optical fiber 15. A plurality of active fiber-bays 17 are optically coupled to optical fiber 15. Redundant fiber-bay 19 is also optically coupled to optical fiber 15. Narrow Band OXC 52 is provided to couple fiber-bays 17 and 19 with optical fiber 54 to the external optical network.

The preferred transmit data flow according to the fourth embodiment as shown in FIG. 4, will now be described in detail. At a customer site, customer interface equipment (CIE) 58 transmits data via optical fibers 54 to narrow band OXC 52. The CIE 58 typically transmits 2048 single wavelength fibers in OC-192c pipes. The 2048 single wavelength fibers are received by narrow band OXC 52 in OC-192c pipes, which are inputted as individual OC-192 channels, each at a single wavelength. Narrow band OXC 52 transmits 256 single wavelength channels to each of the optical fiber bays 17 and 19 via optical fibers 56. The 256 single wavelength channels may comprise 254 active service transmit channels, and two redundant protect transmit channels for example. Fiber bays 17 and 19 receive the 256 single channel wavelengths, and transmit 256 service channels via wavelength division multiplexed (WDM) optical fibers 15. The 256 service channels may comprise 254 active service transmit channels, and two redundant protect transmit channels for example. WDM OXC 50 receives the 256 service channels via optical fiber 15, and transmits to a second node via diversely routed service transmit optical fiber 5 and protect transmit optical fiber 11. WDM OXC 50 thus duplicates the service channels received via optical fibers 15 for transmission via both service transmit optical fiber 5 and protect transmit optical fiber 11.

In the event of a fiber-bay failure, narrow band OXC 52 idles the failed fiber-bay and activates redundant fiber-bay 19, which receives the 256 service channels from OXC 52 via optical fiber 56. In such a configuration, customer interface equipment 58 continues to transmit via optical fiber 54 as if no fiber-bay failure had occurred. Redundant fiber-bay 19 then transmits 256 service channels via WDM optical fiber 15. Similar to narrow band OXC 52, WDM OXC 50 idles the failed fiber-bay, and receives data from redundant fiber-bay 19 via WDM optical fiber 15. WDM OXC 50 continues to transmit to a second node via service transmit optical fiber 5 as if no fiber-bay failure had occurred.

In the event of a fiber-cut in service transmit optical fiber 5, transmission from CIE 58 to WDM OXC 50 proceeds as if no fiber-cut had occurred. WDM OXC 50 transmits via protect transmit optical fiber 11 to the second node. As WDM OXC 50 may be transmitting via service and protect optical fibers 5 and 11 simultaneously, switching may not be required in WDM OXC 50 to compensate for a fiber-cut in service transmit optical fiber 5. Alternatively, WDM OXC 50 may switch from service transmit optical fiber 5 to protect transmit optical fiber 11, thus idling service transmit optical fiber 5.

The preferred receive data flow according to the fourth embodiment as shown in FIG. 4, will now be described in detail. The connection of the equipment is the same as described above; thus only the receive data flow will be described below.

A first node receives data from a second node (FIG. 1) via service receive optical fiber 7 or protect receive optical fiber 9 at WDM OXC 50. WDM OXC 50 selects one of active fiber-bays 17 for demultiplexing the received signal. The received signal typically comprises 256 channels transmitted from the second node (FIG. 1), via optical fibers 7 or 9 as previously described in the transmission data flow. The selected fiber bay 17 then transmits 256 single wavelength channels to narrow band OXC 52 via OC-192c pipes, which are then inputted to the OXC 52 as single wavelength channels on individual fibers. Narrow band OXC 52 then selects which CIE 58 receives the data, and transmits 2048 single wavelength fibers via external optical fibers 54 in OC-192c pipes to the selected CIE 58.

In the event of a fiber-bay failure, WDM OXC 50 idles the failed fiber-bay and activates redundant fiber-bay 19 which receives data from WDM OXC 50 via WDM optical fiber 15. In such a configuration, customer interface equipment 58 continues to receive data via optical fiber 54 as if no fiber-bay failure had occurred. Redundant fiber-bay 19 then transmits 256 single wavelength channels in OC-192c pipes to narrow band OXC 52. Similar to WDM OXC 50, narrow band OXC 52 idles the failed fiber-bay, and receives data from redundant fiber-bay 19 via optical fiber 56. WDM OXC 50 continues to receive from a second node via service receive optical fiber 7 as if no fiber-bay failure had occurred.

In the event of a fiber-cut in service receive optical fiber 7, transmission from WDM OXC 50 to CIE 58 continues as if no fiber-cut had occurred. WDM OXC 50 receives data via protect receive optical fiber 9 from the second node. As WDM OXC 50 may be receiving via service and protect optical fibers 7 and 9 simultaneously, no switching may be required in WDM OXC 50 to compensate for a fiber-cut in service receive optical fiber 7. WDM OXC 50 may still need to switch the output from utilizing service optical fiber 7 to protect optical fiber 9. Alternatively, WDM OXC 50 may switch from service receive optical fiber 7 to protect receive optical fiber 9, thus idling service receive optical fiber 7.

Any number of redundant fiber-bays 19 may be provided in the optical transmission system, wherein the number of redundant fiber-bays 19 is less than the number of active fiber-bays 17.

Several advantages of this fourth embodiment are achieved over a conventional architecture. With the addition of redundant fiber-bays to a conventional network comprising redundant optical fiber and redundant channel equipment, an additional layer of network protection is provided. Further, the number of redundant fiber-bays, redundant channel equipment, and redundant optical fiber may be configured to provide improved performance for a particular implementation. Another advantage of this fourth embodiment is achieved by not requiring double terminal cost to provide protected channels.

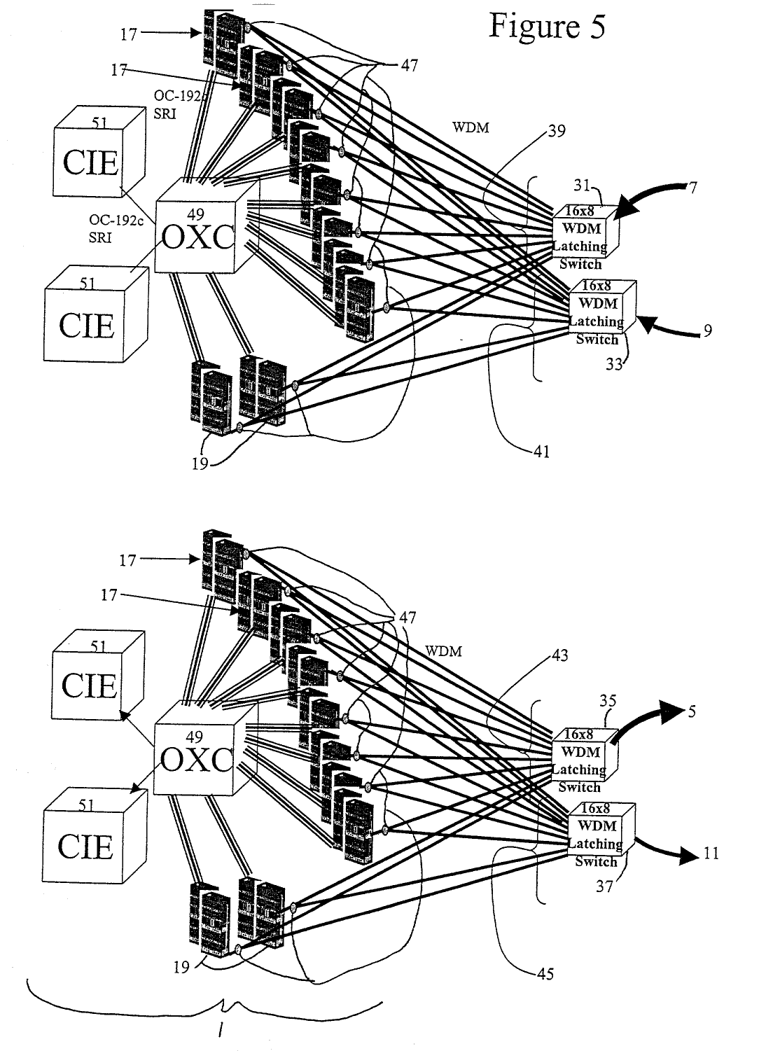

In a fifth embodiment, two nodes communicate via optical fiber (FIG. 1). A single node is shown in FIG. 5. Service receive optical fiber 7 is optically coupled to a 16×8 WDM Latching Switch 31, and to a second node (FIG. 1). Protect receive optical fiber 9 is optically coupled to a 16×8 WDM Latching Switch 33, and to the second node (FIG. 1). Service transmit optical fiber 5 is optically coupled to a 16×8 WDM Latching Switch 35, and to the second node (FIG. 1). Protect transmit optical fiber 11 is optically coupled to a 16×8 WDM Latching Switch 37, and to the second node (FIG. 1). Switches 31, 33, 35, and 37 are positioned within or in close proximity to nodes 1 and 3 (FIG. 1). Switches 31, 33, 35, and 37 may incorporate a 2% tap and photodiode to monitor signal strength so that they can switch when there is a fiber failure.

Data is provided simultaneously through service optical fibers 5 and 7, and protect optical fibers 9 and 11. When a fiber cut occurs on a service optical fiber 5 or 7, the corresponding protect optical fiber 9 or 11 continues to provide data to the respective fiber-bay 17. By simultaneously providing data through service optical fibers 5 and 7, and protect optical fibers 9 and 11, minimal switching time occurs when a service optical fiber 5 or 7 fails as the data is already present in the protect optical fiber. When a fiber cut occurs in a service optical fiber, the optical communication network can immediately transfer to the protect optical fiber without having to resend data from a transmitting node to a receiving node.

Further, switch 31 is optically coupled to service receive optical fibers 39. Switch 33 is optically coupled to protect receive optical fibers 41. Switch 35 is optically coupled to service transmit optical fibers 43. Switch 37 is optically coupled to protect transmit optical fibers 45. A path interface 47 is optically coupled to optical fibers 39 and 41, and 43 and 45, respectively, for each fiber-bay 17 and 19. Path interfaces 47 are typically positioned in close proximity to or within fiber-bays 17 and 19. Path interfaces 47 may comprise: (1) combiners to combine receive optical fibers 39 and 41; (2) switches to switch between receive optical fibers 39 and 41; (3) switches to switch between transmit optical fibers 43 and 45; or (4) splitters to split transmit optical fibers 43 and 45.

When a fiber cut in a service receive optical fiber 7 occurs, the optical communication network changes to use the corresponding protect receive optical fiber 9. Similarly, when a fiber-cut in a service transmit optical fiber 5 occurs, the optical communication network changes to use the corresponding protect transmit optical fiber 11. When passive path interface 47 equipment such as splitters and combiners is utilized, the change between service and protect optical fiber will happen in switches 31, 33, 35, and 37. When active path interface 47 equipment such as switches or OXCs is utilized, a software management operation may be performed by the network to actively change between service and protect optical fiber.

OXC's 49 may be provided to interface fiber-bays 17 with customer interface equipment (CIE) 51. This configuration allows a standard network configuration to be unaffected by changes in a customer's particular needs. CIE 51 may comprise Lucent Bandwidth Managers, for example. OXC 49 switches customer data (from CIE 51) from 17 to 19 when a fiber-bay failure occurs.

By utilizing a network protection architecture comprising a plurality of fiber optic cables including protect optical fiber, redundant channel equipment, and redundant fiber-bays, a reduction in the total number of fiber-bays required may be achieved. This reduction in the required number of fiber-bays may be achieved while still providing system redundancy, resulting in adequate system performance at a reduced cost.

Further, it will be apparent to one skilled in the art that changing between fiber-bays, channel equipment, and optical fibers may be prioritized by delay. For example, a configuration may delay changing channel equipment until a predetermined period of time after changing optical fiber. The optical network would thus wait to change the channel equipment until the network has determined that changing optical fiber did not restore the connection. Similarly, the network may delay changing fiber-bays until a predetermined period of time after changing optical fiber, and the network may delay changing channel equipment until a predetermined period of time after changing fiber-bays. Other prioritization orders also may be used.

Thus, an optical network architecture has been described according to the present invention. Many modifications and variations may be made to the techniques and structures described and illustrated herein without departing from the spirit and scope of the invention. Accordingly, it should be understood that the methods and apparatus described herein are illustrative only and are not limiting upon the scope of the invention.

What is claimed is:

1. An optical network with at least two nodes comprising:
an optical fiber;
at least two active fiber-bays per node optically coupled to said fiber; and
at least one redundant fiber-bay per node optically coupled to said fiber,
wherein when an active fiber-bay of said at least two active fiber-bays fails, said network changes from said failed fiber-bay to a redundant fiber-bay of said at least one redundant fiber-bay, and
wherein the number of said at least one redundant fiber-bays is less than the number of said at least two active fiber-bays.

2. The network of claim 1, wherein the fiber-bays comprise redundant channel equipment and active channel equipment, and wherein when an active channel equipment fails within a first fiber-bay, said first fiber-bay changes from said failed channel equipment to said redundant channel equipment.

3. The network of claim 2, wherein there are 2 redundant channel equipment per 254 active channel equipment.

4. The network of claim 2, wherein there are 2 redundant channel equipment per 46 active channel equipment.

5. The network of claim 2, wherein when the number of failed channel equipment exceeds the number of redundant channel equipment provided within a given fiber-bay, the network changes to a redundant fiber-bay.

6. The network of claim 1, wherein there is one redundant fiber-bay per eight active fiber-bays.

7. The network of claim 1, wherein the ratio of active fiber-bays to redundant fiber-bays is one of 6:1 and 4:1.

8. The network of claim 1, wherein the optical fiber comprises:
a service transmit optical fiber;
a protect transmit optical fiber;
a service receive optical fiber; and
a protect receive optical fiber,
wherein said network changes from said service transmit optical fiber to said protect transmit optical fiber when said service transmit optical fiber fails,
wherein said network changes from said service receive optical fiber to said protect receive optical fiber when said service receive optical fiber fails.

9. The network of claim 1, wherein the optical network is a submersible optical network.

10. The network of claim 8, wherein when a connection fails, the network changes fiber-bays after waiting a predetermined amount of time after changing optical fiber.

11. The network of claim 2, wherein when a connection fails, the network changes channel equipment after waiting a predetermined amount of time after changing fiber-bays.

12. An optical network with at least two nodes comprising:
an optical fiber comprising:
a service transmit optical fiber;
a protect transmit optical fiber;
a service receive optical fiber; and
a protect receive optical fiber; and
at least two active fiber-bays per node optically coupled to said fiber; and
at least one redundant fiber-bay per node optically coupled to said fiber,
wherein said fiber-bays comprise:
active channel equipment; and
redundant channel equipment,
wherein when a channel equipment fails, said fiber-bay changes from said failed channel equipment to said redundant channel equipment,
wherein when an active fiber-bay fails, said network changes from said failed fiber-bay to a redundant fiber-bay,
wherein the number of redundant fiber-bays is less than the number of active fiber-bays,
wherein said network changes from said service transmit optical fiber to said protect transmit optical fiber when said service transmit optical fiber fails, and
wherein said network changes from said service receive optical fiber to said protect receive optical fiber when said service receive optical fiber fails.

13. The network of claim 12, wherein there is one redundant fiber-bay per eight active fiber-bays.

14. The network of claim 12, wherein the ratio of active fiber-bays to redundant fiber-bays is one of 6:1 and 4:1.

15. The network of claim 12, wherein there are 2 redundant channel equipment per 254 active channel equipment.

16. The network of claim 12, wherein there are 2 redundant channel equipment per 46 active channel equipment.

17. The network of claim 12, wherein the optical network is a submersible optical network.

18. The network of claim 12, wherein when the number of failed channel equipment exceeds the number of redundant channel equipment provided within a given fiber-bay, the network changes to a redundant fiber bay.

19. A method of transporting a signal via optical fiber comprising the steps of:
transmitting an optical signal via an active optical fiber;
changing to a redundant optical fiber when a cut in an active optical fiber occurs; and
changing to a redundant fiber-bay when an active fiber-bay fails,
wherein the number of redundant fiber-bays is less than the number of active fiber-bays.

20. The method of claim 19 further comprising the step of: changing to redundant channel equipment within an active fiber-bay when an active channel equipment fails.

21. The method of claim 20, wherein there are 2 redundant channel equipment per 254 active channel equipment.

22. The method of claim 20, wherein there are 2 redundant channel equipment per 46 active channel equipment.

23. The method of claim 19, wherein there is one redundant fiber-bay per eight active fiber-bays.

24. The method of claim 19, wherein the ratio of active fiber-bays to redundant fiber-bays is one of 6:1 and 4:1.

25. The method of claim 20, further comprising the step of: changing to a redundant fiber-bay when the number of failed channel equipment exceeds the number of redundant channel equipment provided within a given fiber-bay.
